(19) United States
(12) Patent Application Publication
(10) Pub. No.: US 2020/0011210 A1
(43) Pub. Date: Jan. 9, 2020

(54) A LIQUID AIR ENGINE AND A METHOD OF OPERATING A LIQUID AIR ENGINE, AND A METHOD OF OPERATING AN ENGINE AND A METHOD AND SYSTEM FOR LIQUEFYING AIR

(71) Applicant: EPICAM LIMITED, Cambridge Cambridgeshire (GB)

(72) Inventor: Anthony O. DYE, Cambridge Cambridgeshire (GB)

(21) Appl. No.: 16/490,199

(22) PCT Filed: Feb. 27, 2018
(86) PCT No.: PCT/EP2018/054851

§ 371 Date: Aug. 30, 2019

(30) Foreign Application Priority Data
Mar. 1, 2017 (GB) 1703332.5

(51) Int. Cl. F01K 25/10; F17C 7/04

(52) U.S. Cl. CPC F01K 25/10; F02M 21/0221; F17C 7/04

(57) ABSTRACT

The invention provides a cryogen engine, comprising a first rotor rotatable about a first axis and having at its periphery a recess bounded by a curved surface, and a second rotor counter-rotatable to said first rotor about a second axis, parallel to said first axis, and having a radial lobe bounded by a curved surface, the first and second rotors being coupled for intermeshing rotation, wherein the first and second rotors of each section intermesh in such a manner that on rotation thereof, a transient chamber of variable volume is defined, the transient chamber having a progressively increasing volume between the recess and lobe surfaces; a cryogen injector arranged to inject an amount of cryogenic fluid into the transient chamber once it has formed, such that expansion of the cryogen drives the engine. The invention also provides a method of operating an engine and a method of and system for liquefying air.

The present invention relates to a liquid air engine, a method of operating a liquid air engine and a method of liquefying air.

Cryogenic engines have been developed in order to convert the volume increase of the cryogenic working fluid when it changes state from liquid to gas, into pressure in order to provide energy to the working member of an expansion engine which is capable of converting gaseous pressure into output shaft power. It is generally accepted that engines which use a displacement mechanism for effecting this type of pressure conversion to power are well suited for this purpose because of their capability to utilise a large pressure range in a single stage expansion process. Most common types of displacement engines use reciprocating pistons which operate crank mechanisms for shaft power delivery. However, reciprocating piston engines suffer from substantial internal resistance which arises mainly from friction between the piston and the cylinder. This places severe limitations on their use in cryogenic engine applications because the energy release from expansion within any given size of cylinder is not sufficiently greater than the energy required to overcome the friction associated with the given cylinder in order to provide a prime mover machine of generally useful application.

Attempts have been made to increase the power output from cryogenic piston engines by supplementing the energy supply in the cylinder by adding heat from external sources. See, for example, US-A-2015/0352940. Here, there is described a system comprising a cryogenic engine and a power generation apparatus. The cryogenic engine and the power generation apparatus are coupled with each other to permit the cryogenic engine and the power generation apparatus to work cooperatively with each other in what is defined as a synergistic manner. The engine and the power generation apparatus are mechanically and optionally thermally coupled with each other so that the output means is shared between the cryogenic engine and the power generation apparatus and the two systems can thus be operated in a more power efficient manner and may also thermally interact to the potential advantage of both performance and economy. However, the synergistic supplementary energy combination has not been shown to be sufficient to produce, from the cryogenic engine alone, a piston-driven engine with power density comparable with or even approaching those of internal combustion piston engines and also adds significant cost.

According to a first aspect of the present invention, there is provided a cryogen engine, comprising a first rotor rotatable about a first axis and having at its periphery a recess bounded by a curved surface, and a second rotor counter-rotatable to said first rotor about a second axis, parallel to said first axis, and having a radial lobe bounded by a curved surface, the first and second rotors being coupled for intermeshing rotation, wherein the first and second rotors of each section intermesh in such a manner that on rotation thereof, a transient chamber of variable volume is defined, the transient chamber having a progressively increasing volume between the recess and lobe surfaces; a cryogen injector arranged to inject a charge of cryogenic fluid into the transient chamber once it has formed, such that expansion of the cryogen drives the engine. The cryogen injector is preferably arranged to provide the charge of cryogenic fluid at near-ambient temperature in super-critical gaseous state.

Typically the charge could be of the volume of up to 5 cc. Preferably the charge would be about 3 cc and most preferably the charge would be about 1 cc.

A cryogen driven engine is provided that overcomes problems associated with known cryogen engines such as those referred to above and described in, say, US-A-2015/0352940. The provision of rotors including a first rotor rotatable about a first axis and having at its periphery a recess bounded by a curved surface, and a second rotor counter-rotatable to said first rotor about a second axis, parallel to said first axis, and having a radial lobe bounded by a curved surface, the first and second rotors being coupled for intermeshing rotation, wherein the first and second rotors of each section intermesh in such a manner that on rotation thereof, a transient chamber of variable volume is defined, the transient chamber having a progressively increasing volume between the recess and lobe surfaces means that friction between the interacting rotor surfaces is effectively eliminated or at the very least substantially reduced as compared to known cryogen displacement engines

Preferably, the paired rotors which provide the displacement expansion have no contact either with each other or their stator housing. The absence of mechanical friction, together with the simple rotary design, facilitates operation at high rotational speeds.

In embodiments, during each complete cycle of rotation of each of the rotors a plurality of expansion processes occur. The short duration of the interactive expansion cycle, e.g. approximately 90 degrees rotation of the main rotor, also facilitates a high frequency of individual expansion cycles. This enables power densities to be achieved, as measured in terms of power output per unit of working expansion volume, which are greatly in excess of those possible with IC engines. This is possible because the expansion energy released per cycle, despite being significantly less than the energy released from combustion expansion, can be compensated for by the very high frequency of the cycles.

The rotors can be sized as required but typically they would have diameters of between 80 and 150 mm and more preferably between 100 and 130 mm. In one example rotor diameters are approximately 110 mm. The recess depth and lobes lengths would typically be about 60-95% of the rotor radius, dependent on the rotor axis diameter which could vary according to specific engine design. Rotor lengths can also be varied according to design but preferably would be between 70 and 140 mm, more preferably between 90 and 120 mm and in a specific example 100 mm.

The power output from a modern supercharged gasoline engine with 1,200 cc. of expansion volume capacity and operating at a maximum speed of 6,000 RPM might produce approximately 100 HP, whereas a cryogenic engine according to the present invention with the same expansion volume is capable of operating at 20,000 RPM and producing approximately 2,000 HP.

Preferably, the cryogen engine comprises a heat source for providing heat to the engine during operation.

Preferably, the heat source is super-heated water.

Providing a heat source in the form of superheated water is advantageous since it means that a precisely metered charge of the water can easily be injected into the working chamber of the engine as needed to ensure that overall the required amount of heat is provided to generate a general isothermal cycle. That means that thermal stresses that typically occur with other types of engine, such as an internal combustion engine can be avoided.

The volumes of cryogen or superheated water provided as inputs or “charges” to the engine can in be accurately controlled or metered using, for example, injectors such as electronically controlled injectors.

Preferably, the cryogen engine comprises at least one super-heated water injector arranged to inject a metered amount of super-heated water into the transient chamber once it has formed, such that an expansion stage of the cycle is substantially isothermal. Preferably more than one super-heated water injector is arranged to inject a metered amount of super-heated water into the transient chamber during a cycle of operation. The use of more than one super-heated water injector means that the position and amounts of heat provided to a transient chamber can be accurately controlled and/or varied as desired. It also means that the precise position of heat injection can be controlled to match the profile of heat requirements to ensure that an overall isothermal process is achieved and also that the temperature distribution with respect to space or volume within the engine is accurately controlled and maintained substantially uniform or flat. The actual positions of the two superheated water injectors shown in, say, Figures, 5B and 6B below are merely exemplary.

Preferably, the cryogen engine comprises a cryogen source.

Preferably, the cryogen source is a storage tank for storing a liquid cryogen.

Preferably, the cryogen engine comprises a high pressure pump for pumping a cryogen to the cryogen injector.

Preferably, the high pressure pump is provided within, e.g. submerged within, the storage tank. Providing the cryogen pump within storage tank means that the problem of thermal insulation of the pump is avoided.

Preferably, the high pressure pump is provided adjacent to the storage tank.

Preferably, the engine comprises end walls enclosing the axial ends of the rotors and wherein one of the end walls has a port positioned for delivery of the cryogen to the transient chamber of varying volume during an expansion cycle shortly after the transient chamber is first defined.

Preferably, the port is positioned for delivery of the cryogen to the transient chamber of varying volume during the first 0-10 degrees of rotation of the rotors after the establishment of the transient chamber of varying volume.

Preferably, the end wall has at least two ports and wherein one of them is arranged for the provision of cryogen to the transient chamber of varying volume during an expansion cycle, and another is arranged for the provision of a heated liquid to the transient chamber of varying volume.

Preferably, a metered amount of cryogen and heated liquid are provided for an expansion cycle so as to ensure that overall the expansion cycle is isothermal.

According to a second aspect of the present invention, there is provided a method of operating a cryogen engine, the method comprising, in an engine comprising a first rotor rotatable about a first axis and having at its periphery a recess bounded by a curved surface, and a second rotor counter-rotatable to said first rotor about a second axis, parallel to said first axis, and having a radial lobe bounded by a curved surface, the first and second rotors being coupled for intermeshing rotation, wherein the first and second rotors of each section intermesh in such a manner that on rotation thereof, a transient chamber of variable volume is defined, the transient chamber having a progressively increasing volume between the recess and lobe surfaces; injecting a metered amount of cryogenic working fluid in super-critical state into the transient chamber once it has formed, such that expansion of the cryogen drives the engine.

Preferably, the method comprises at the same time as injecting the cryogen or shortly thereafter, injecting a metered amount of heated fluid into the expansion chamber to achieve isothermal expansion within the transient chamber.

Preferably, the method comprises operating an engine according to the first aspect of the present invention.

According to a third aspect of the present invention, there is provided a method of liquefying air, the method comprising providing a liquefaction system including at least a first power line and a second power line, wherein the first power line has at least one compressor stage and at least one expander and is arranged to compress air and then expand air so as to provide a product stream of liquid air, and wherein the second power line has at least one compressor stage and at least one expander and is arranged to provide a flow of coolant for the first power line, the method comprising: in the first power line, receiving a flow of air; compressing the received air in a compressor having a first rotor rotatable about a first axis and having at its periphery a recess bounded by a curved surface, and a second rotor counter-rotatable to said first rotor about a second axis, parallel to said first axis, and having a radial lobe bounded by a curved surface, the first and second rotors being coupled for intermeshing rotation, wherein the first and second rotors of each section intermesh in such a manner that on rotation thereof, a transient chamber of progressively decreasing volume is defined between the recess and lobe surfaces; and removing heat from the compressed air; providing the cooled compressed air to an expander and expanding the air so as to cause a drop in temperature of the air and thereby liquefy the air, wherein the expander has a first rotor rotatable about a first axis and having at its periphery a recess bounded by a curved surface, and a second rotor counter-rotatable to said first rotor about a second axis, parallel to said first axis, and having a radial lobe bounded by a curved surface, the first and second rotors being coupled for intermeshing rotation, wherein the first and second rotors of each section intermesh in such a manner that on rotation thereof, a transient chamber of progressively increasing volume is defined between the recess and lobe surfaces.

Preferably, the second power line has 2 or more compressor stages arranged in series, and wherein the method comprises removing heat from the compressed air at the output of one or more of the plurality of compressor stages before it is provided as an input to the next compressor stage.

Preferably, the second power line has 2 or more compressor stages arranged in series, and wherein the method comprises removing heat from the compressed air at the output of one or more of the plurality of compressor stages before it is provided as an input to the next compressor stage, and wherein the method comprises: coupling cooled air from the compressor of the second power line to one or more heat exchangers thereby to provide cooling of compressed air in the first power line.

Preferably, the method comprises providing a plurality of second power lines and coupling cooled air from an expander of each of the second power lines to provide cooling to the first power line.

Preferably, there are at least three stages of compressor within each power line and they are arranged to provide a compression ratio of between 2:1 and 8:1, preferably between 3:1 and 6:1 and more preferably a compression ratio of 4:1.

According to a fourth aspect of the present invention, there is provided a system for liquefying air, the system comprising: a first power line having a compressor having a first rotor rotatable about a first axis and having at its periphery a recess bounded by a curved surface, and a second rotor counter-rotatable to said first rotor about a second axis, parallel to said first axis, and having a radial lobe bounded by a curved surface, the first and second rotors being coupled for intermeshing rotation, wherein the first and second rotors of each section intermesh in such a manner that on rotation thereof, a transient chamber of progressively decreasing volume is defined between the recess and lobe surfaces; and a heat exchanger for removing heat from the compressed air; an expander arranged to expand the air so as to cause a drop in temperature of the air and thereby liquefy the air, wherein the expander has a first rotor rotatable about a first axis and having at its periphery a recess bounded by a curved surface, and a second rotor counter-rotatable to said first rotor about a second axis, parallel to said first axis, and having a radial lobe bounded by a curved surface, the first and second rotors being coupled for intermeshing rotation, wherein the first and second rotors of each section intermesh in such a manner that on rotation thereof, a transient chamber of progressively increasing volume is defined between the recess and lobe surfaces.

Preferably, the second power line has at least one compressor stage and at least one expander and is arranged to provide a flow of coolant for the first power line.

Preferably, the second power line has 2 or more compressor stages arranged in series, and wherein the system has one or more heat exchangers configured in use to remove heat from the compressed air at the output of one or more of the plurality of compressor stages before it is provided as an input to the next compressor stage or to the expander of the 2^{nd} power line.

Preferably, there are provided 2 or more 2^{nd} power lines arranged to provide cooling to the first power line.

In the system for liquefying air it will be appreciated that plural power lines are provided and that within each power line there is provided at least one expander and at least one compressor. It is preferred that all of the expanders and compressors within the system are of the low friction rotary type described herein.

By providing all of the rotary devices used within the system as the low friction type described above the frictional losses throughout the entire system can be minimised and the efficiency maximised.

It is possible that one or more of them might not be (so long as at least one of them is). Preferably, within the first power line at least the compressor (or at least one of the compressors where more than one is provided) is of the type having first and second rotors. A first rotor is rotatable about a first axis and has at its periphery a recess bounded by a curved surface, and a second rotor counter-rotatable to said first rotor about a second axis, parallel to said first axis, has a radial lobe bounded by a curved surface, the first and second rotors being coupled for intermeshing rotation. The first and second rotors intermesh in such a manner that on rotation thereof, a transient chamber of variable volume is defined, the transient chamber having a progressively increasing volume between the recess and lobe surfaces. Preferably also the expander has this general form although of course in use the transient chamber will be arranged to increase in volume during a cycle of rotor interaction.

Embodiments of the present invention will now be described in detail with reference to the accompanying drawings, in which:

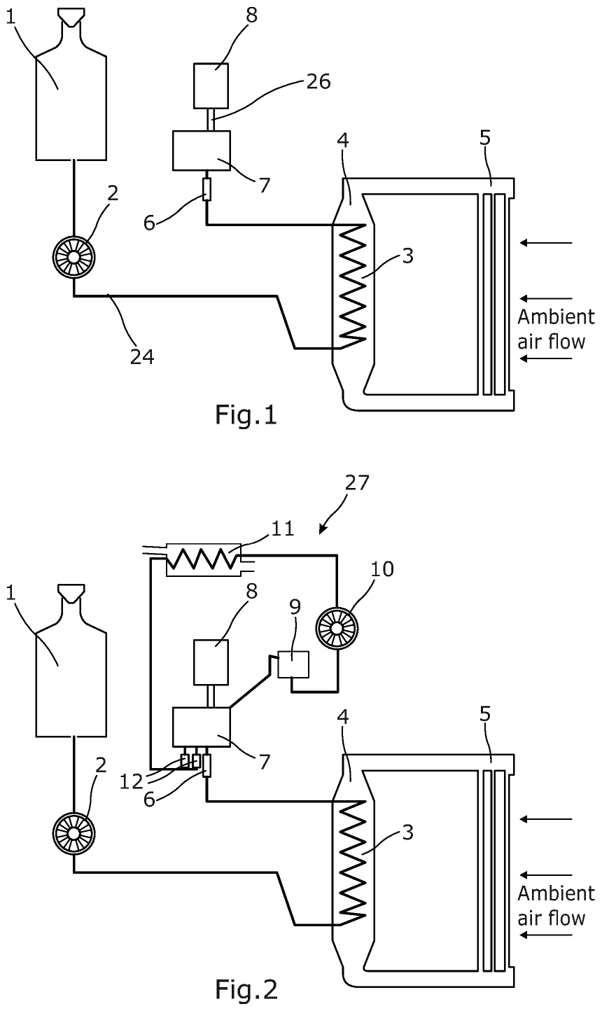

FIG. 1 is a schematic representation of an engine and energy supply system;

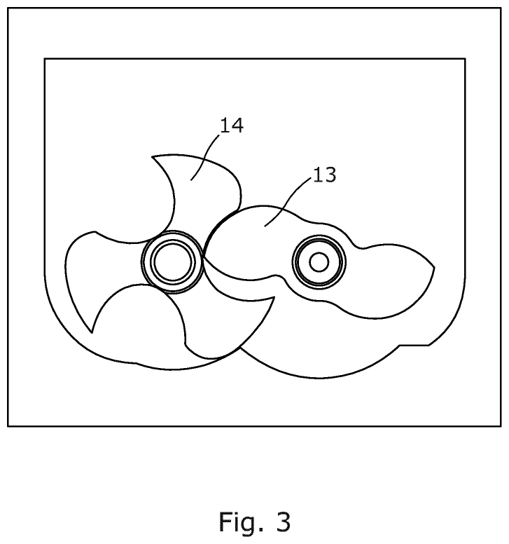

FIG. 2 is a further example of an engine and energy supply system;

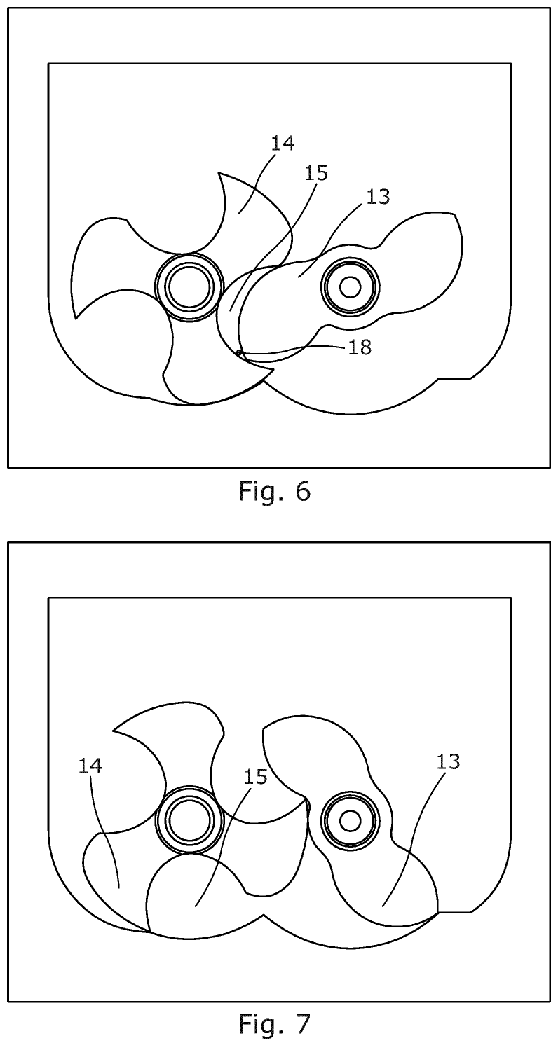

FIGS. 3 to 7 show schematic views of the positions of a lobe and rotor and pocket rotor within an engine during an expansion cycle; and,

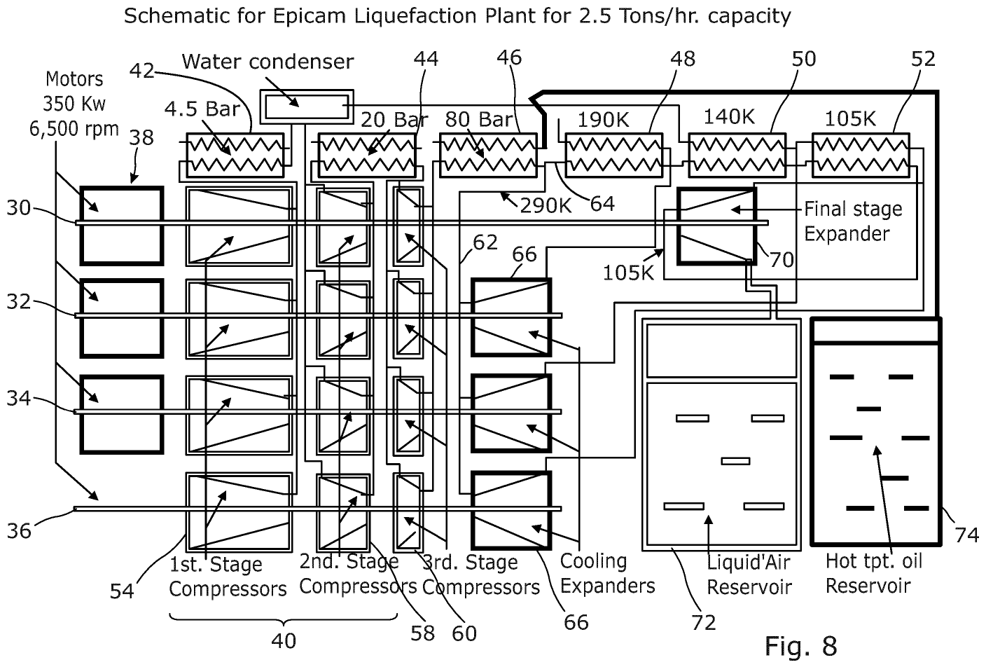

FIG. 8 shows a schematic representation of a system for liquefying air.

FIG. 1 is a schematic representation of an engine system including a liquid air engine 7 and a source of liquid air 1. Liquid air within the liquid air source 1 functions as an energy supply. As will be described below, the system provides a simple and efficient way for converting the volume increase of a cryogenic working fluid when it changes state from liquid to gas into pressure to provide energy to drive an engine. The description refers to a cryogen or to liquid air. It will be appreciated that the method and system described and claimed herein apply to cryogenic fluids more generally and are not limited specifically to liquid air.

In the examples described herein, a rotary engine with expansion chambers of a particular type and configuration is used, although it will be appreciated that the method and engine is not limited to use only of such expansion chambers. The method does work particularly well with engines having expansion chambers like those of the rotary device described in, for example, WO-A-91/06747, the entire content of which is hereby incorporated by reference. The rotary device has a first rotor rotatable about a first axis and having at its periphery a recess bounded by a curved surface; and a second rotor counter-rotatable to the first rotor about a second axis, parallel to the first axis, and having a radial lobe bounded by a curved surface. The rotors intermesh such that, upon rotation, a transient chamber of progressively increasing volume (or decreasing if used as a compressor) is defined between them.

The system of FIG. 1 comprises a thermally insulated reservoir 1 for storing a cryogenic fluid such as liquid air. A liquid air engine 7 is provided arranged to receive the cryogen such as liquid air that has been heated so as to be super-critical upon its introduction into the engine 7 via an injector 6, which may be an electronically controlled injector. The skilled person would be able to select from commercially available electronically controllable fluid injectors for use as the injectors of the present system. As explained above, typically the charge of cryogen provided to a transient chamber of the engine could be of the volume of up to 5 cc, but preferably would be about 3 cc or about 1 cc.

A heat exchanger 3 is provided through which the liquid air is pumped via a cryogenic pump 2. The cryogenic pump 2, in one non-limiting example is submerged in the reservoir 1. In another example, the pump 2 is provided external to the reservoir but immediately adjacent to it. If the pump is provided externally to the reservoir, then the pump 2 will itself be provided with effective thermal insulation to prevent vaporisation of the cryogen. The pump 2 is configured so as to be able to maintain a constant delivery pressure of between 200 and 400 Bar, preferably approximately 350 Bar, and also so as not to permit any reverse flow.

A high pressure conduit 24 is provided which enables passage of pressurised liquid air through the heat exchanger 3 and on to the injector 6. The conduit 24 may be a pipe or tube of a suitable high pressure resistant material. The heat exchanger 3 comprises a volume of anti-freeze liquid 4, such as ethylene glycol or propylene glycol circulating through a radiator 5. The radiator 5 is warmed by ambient air flow. In other words, the radiator 5 may be thought of as operating in reverse since it services to absorb heat from ambient air, rather than to radiate heat to the atmosphere. The capacity of the heat exchanger is selected or configured such that the working fluid reaches a temperature very close to the local ambient temperature at its exit from the heat exchanger 3. For example, in one example the heat exchanger is arranged to provide the working fluid at a temperature of about 10-30 degrees C. or in other examples the working fluid may be provided at temperatures ranging between −10 to +40 degrees C.

Continuing in the high pressure conduit 24, the working fluid is then delivered to the electronically controlled injector 6 for pulsed delivery directly into a transient chamber of varying volume of the engine 7, to be described in greater detail below.

The rotary engine 7 has an output shaft 26 which may be coupled to a system 8. The system 8 may be a power transmission medium which can be a generator for delivering electrical power, a transmission system for vehicle propulsion or indeed any type of system that might require an input of rotary power.

The cryogenic engine employs novel means to release the pressure energy from a charge of liquid air working fluid. A thermally insulated storage reservoir preferably contains this working fluid which is passed through an internal high pressure passage of a heat exchanger. Ambient air, passed through the outer passage of the heat exchanger, warms the working fluid to near ambient temperature at the exit from the heat exchanger, which leads directly to an electronically controlled injector mounted on the end-wall of the engine, and which prevents expansion of the working fluid in the positive direction of flow.

However, flow in the negative direction is preferably also prevented, e.g. by means of a cryogenic pump located downstream of the reservoir and which supports flow in the positive direction only, whilst maintaining the pressure at, say 250-400 Bar (preferably at about 350 Bar), which pressure naturally occurs when liquid air, trapped in a pressure vessel is warmed to ambient temperature. This means that as the working fluid passes through the heat exchanger, its temperature and pressure rises beyond the critical temperature at about 130K, after which it remains as a super-critical fluid in gaseous state at a pressure of about 350 Bar and is presented to the injector at near ambient temperature in this state.

Referring to FIG. 2, components common to the system of FIG. 1 are numbered in the same way as in FIG. 1. It can be seen that as well as the components of the system shown in FIG. 1, the system of FIG. 2 further comprises a closed subsystem 27 for the injection of super-heated water to the engine 7. Typically, the water provided by the system 27 is provided to the engine in a super-heated state approximately at a temperature of 150 degrees C.

The system 27 comprises a heat exchanger 11 arranged to receive water via a high pressure pump 10 in communication with a reservoir or condenser 9. Any suitable high pressure pump may be used so long as it is able to provide the water at pressures within the range 150 to 250 Bar. Injectors 12 are provided for controlled injection of metered amounts of super-heated water into the engine 7. The injectors are arranged so as to inject super-heated water to the engine 7, as will be explained in greater detail below, in combination or interspersed with the super-critical air provided from the reservoir 1.

The cooling effect of the expansion of super-critical air in the transient chamber of the engine 7, causes the water to condense to a large extent by the time it exits the transient chamber of the engine 7. This process may be completed in the condenser 9, where liquid water collects before being pressurised in the pump 10 for provision to the heat exchanger 11 for super-heating.

The injection, or more generally the provision, of super-heated water to the engine 7 together with the super-critical ambient temperature working fluid air, functions as a heat source which therefore ensures isothermal expansion of the working fluid air as it does work and drives the engine 7. Thus, by control of the relative amounts of super-heated water and super-critical air provided to the engine 7, a substantially isothermal process can be achieved. This is a very significant factor since it means that even whilst operating at maximum power the thermal stresses on components within the engine, e.g. the rotors, bearings, shafts etc can be minimised or entirely avoided. This contrasts markedly with other types of engines such as the internal combustion engine in which thermal stresses can be significant during operation and become more so as engine power output is driven to the maximum capacity.

Furthermore, the addition of heat, e.g. via the medium of superheated water, provides additional energy to the engine during its cycle of operation. Indeed, in embodiments, the heat added accounts for approaching more than 30% of the power output of the engine. In some embodiments, the heat added accounts for even more of the power output of the engine, e.g. 40 or even 45 or 50% of the power output of the engine. Thus the addition of superheated water has a number of synergistic beneficial effects. Not only can it be used to provide an isothermal energy conversion process, but in doing so can significantly add to the power output of the engine.

An alternative source for heat to achieve isothermal expansion in the engine is available when it is used in some applications, such as transport applications. If it is desired to avoid the use of a heat transport oil (as might be used in the heat exchanger 11 in FIG. 2), useful heat from the ambient air which the vehicle is passing through can be collected. In one example, a reservoir (not shown) of ambient heated water is provided which is injected into the transient chamber in the form of finely atomised droplets. The droplets transfer heat into the rapidly cooling expanding air in the transient chamber of the engine and collect at the exit as condensed cold water which can then be recycled round the system. The ambient heated water receives its heat via a heat exchanger (also not shown) richly supplied with ambient air.

This is in some ways analogous to the heating of the liquid air described above. In the case of the heating of the liquid air, a heat exchanger 4 and 5 serves to receive heat from the flow of ambient air. In the case of heating water for injection to the engine, again a flow of ambient air could be used as the heat source. A heat exchanger, which could be the same as the heat exchanger 4 and 5 used for the liquid air (or an entirely different dedicated heat exchanger), is provided arranged to receive a flow of ambient air which is capable of sufficiently heating water for use as the heat source in the engine. This sub-system could be supplemented by a limited input of storage heat from a smaller source on board the vehicle, e.g. an electric heater.

The energy conversion process, by which the energy stored within the cryogenic air from source 1 is converted to rotary output from the engine 7 will now be described with reference to a single cycle of operation. As explained above, any suitable engine hardware can be used to provide the energy conversion, but a particularly desirable form for the energy conversion device will be rotary engine of the type described in, WO-A-91/06747 or WO-A-2011/073674 (the entire contents of which is hereby incorporated by reference). The particular advantage of rotary devices of the types described in these two international patent applications is the low or zero friction between the surfaces of the lobe and recess rotors defining the transient chambers of varying volume of the engine. This contrasts markedly with other types of engine, such as, say a conventional piston engine.

Referring to FIG. 3, as can be seen, a pair of rotors 13 and 14 is provided. A lobe rotor 13 is provided and arranged to rotate counter clockwise and a recess rotor 14 is provided and arranged to rotate in an intermeshing manner with the lobe rotor in a clockwise direction. The view shown in FIG. 3, it will be understood, represents the position of the lobe and pocket rotors at an initial stage during an expansion cycle, as if they were viewed through a transparent end wall of the engine. The positions of the injection delivery points for both super-critical air and super-heated water represent the relative positions of the ports or delivery orifices of the respective injectors and in a position mounted in the end wall of the engine. It will also be understood that the rotors as shown extend axially into the page and what can be seen in the figures shows merely an end view. Thus the gap that forms between the lobe and the recess and appears as a two dimensional shape, in fact extends into the page such as to define a volume of a transient chamber. The rotors could be straight and of uniform unchanging cross section along their entire axial length or some degree of twisting along their length could be provided.

The start of an expansion cycle is signalled by the initiation of a new transient chamber formed between a currently interacting lobe and pocket combination of the paired rotors as shown in FIG. 3. The rate of growth of the volume of the new transient chamber in the first few degrees of rotation of the lobe rotor will vary between designs of the rotor profiles which are possible within the scope of the rotor technology as disclosed in WO-A-2011/073674. In a preferred embodiment, the rotors provide a transient chamber with a maximum volume increase of 400×the volume reached in the first 10 degrees of rotation after the start of the cycle.

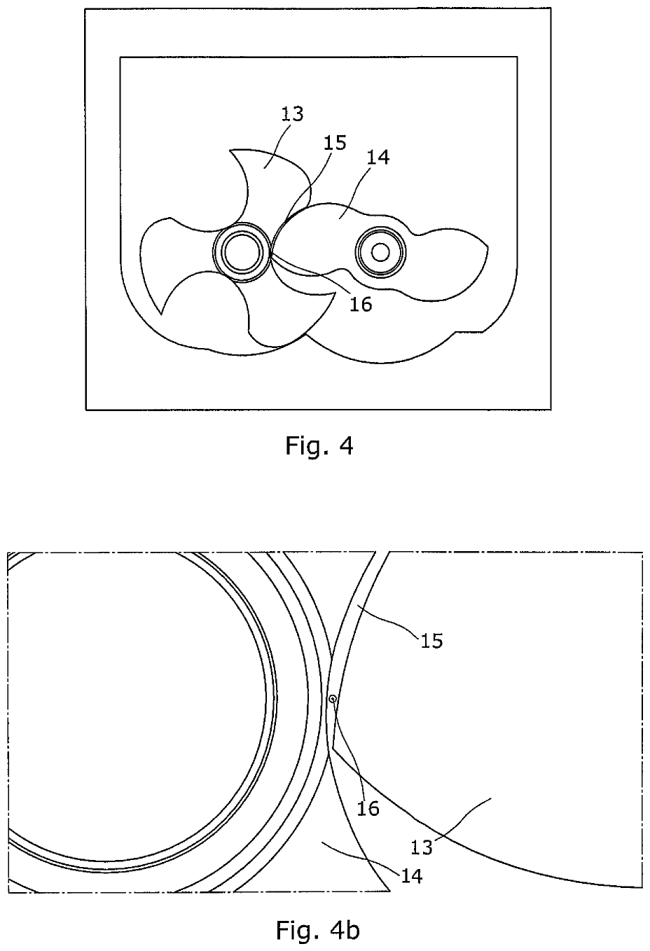

The delivery of the super-critical air working fluid at near ambient temperature is timed to occur within an early period of growth of the transient chamber i.e., within the first 5 or 10 degrees of rotation of the lobed rotor, as can be seen in FIG. 4. Here, the initial establishment of the transient chamber 15 can be seen. The transient chamber 15 is defined entirely by the surfaces of the recess rotor 13 and the lobe rotor 14. This contrasts with a conventional screw expander in which the outer axial wall at all times during the cycle of rotation forms a defining wall of the transient chamber.

Looking again at FIG. 4, it can be seen that in the end view there are two near-contact points of interaction between the lobe surface and the surface of the recess within the recess rotor 13. These near-contact points, when extended along the axial length of the rotors will define lines of minimal leakage. Thus, the transient chamber is a chamber which extends along the axial length of the device.

The timing of the start of the injection pulse is determined by a signal from a shaft encoder which may be provided as part of an engine control system or simply as a control unit on the lobe rotor shaft (not shown). The duration of the pulse for maximum torque delivery of the engine is time-based with reference to the maximum flow capacity of the injector 6. This is regardless of the operating speed of the engine. For part-load operation, the pulse duration is shortened in proportion to the extent of the load reduction from the full load situation. Correspondingly, the maximum volume of the transient chamber 15 is also reduced in the same proportion, using the variable geometry system (not shown here) that can be used with rotors of this type from their inception and effected under software control.

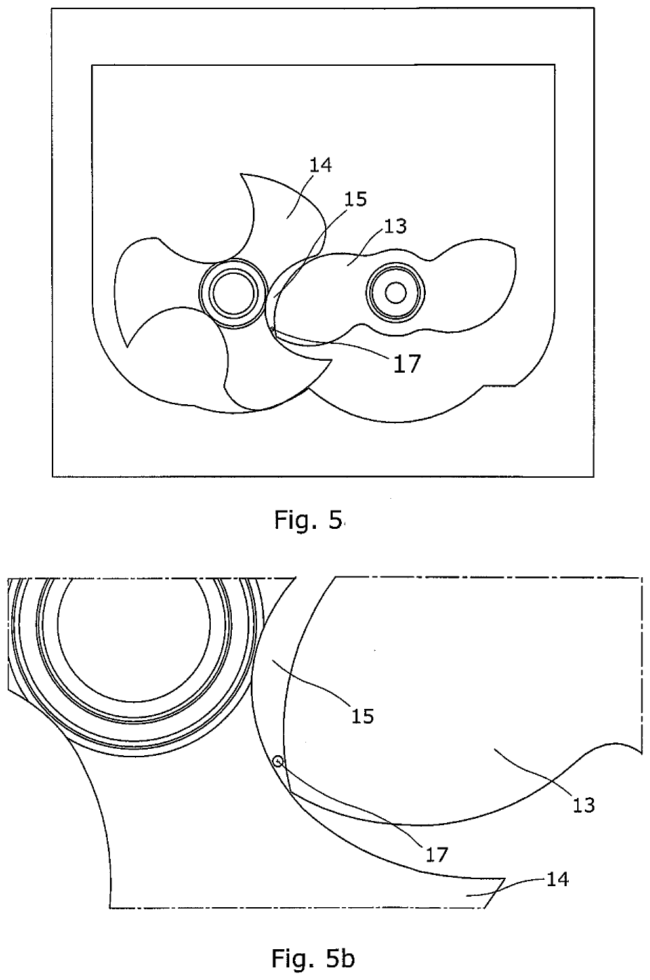

The delivery of super-heated water, as explained above with respect to FIG. 2 via the injectors 12 is also effected under standard programme control. Preferably two injectors 12 are provided for the delivery of super-heated water. Delivery from the first injector is preferably timed to occur soon after completion of the delivery of super-critical air or can be delivered from the second injector 12 at some other time during the expansion cycle. This can be seen with reference to FIG. 5.

FIG. 4b shows an enlarged section of the interacting region between the tip of the lobe and the surface of the recess. The position 16 on an end wall of the engine is the position at which the injector 6 is configured to provide the input of super-critical air as the working fluid. The transient chamber 15 defined between the surfaces of the lobe and recess can be seen clearly in FIG. 4b. As can be seen there is a minimal clearance between the tip of the lobe of the lobe rotor and the surface of the recess of the recess rotor. This ensures that the device can operate with substantially zero friction between the interacting surfaces of the lobes and recesses. Typically the clearance between the sliding contact points on the lobe and rotor surfaces would be of the order of 10-20 μm, which is large enough to avoid any frictional losses whilst being small enough to avoid any significant fluid leakage or back flow in operation.

In FIG. 5, the delivery of super-heated water can be seen to occur via the injectors 12 at position 17. As explained above, this is timed to occur soon after completion of the delivery of super-critical air. A second injector at position 18 is provided which is arranged to provide a second pulsed duration of super-heated water injector and determined under experimental conditions to ensure that just enough heat is added to achieve isothermal expansion with data-mapping in relation to the temperature history of the working fluid over the whole expansion cycle for the entire speed/load operating map for the engine.

Referring to FIG. 6, it can be seen via the two sliding points of near contact on the surface of the recess in question, the transient chamber 15 has significantly increased in volume. Due to the very small initial volume of the transient chamber 15 the expansion ratio achieved is significant.

Referring to FIG. 9, by the time the relative rotation of the rotors has reached this stage, the expansion cycle is virtually complete and so the subsequent lobe and recess pair can start interaction with the commencement of an entirely new expansion cycle.

The use of super-heated water provides an efficient and effective means of providing to the expansion cycle sufficient heat so as to ensure that the expansion of the air does not itself cause particularly low temperatures to occur within the engine. In other words a substantially isothermal expansion process is achieved. Other forms of heat source could be used for providing the required amount of heat to the engine during its operation, but super-heated water is preferred since it means that there is no problem of undesirable exhaust gases or other such outputs being produced. It will be appreciated that the exhaust effluents from the engine will simply be air and water and therefore entirely atmospherically benign.

A means and method of air liquefaction will now be described with reference to FIG. 8. It will be appreciated that the engine and system described above will work with any suitable source of liquid air or cryogenic liquid. What will now be described is a method and system for producing liquid air.

Four power lines 30, 32, 34 and 36 are shown, each of which is driven by an electric motor 38 supplied with energy preferably sourced from surplus renewable power. Each of the motors 38 drives a 3 stage compressor 40. Each of the 3 stage compressors 40 itself is made up of three compressors. The stages are labelled as “1^{st} stage compressor”, “2^{nd} stage compressor”, and “3^{rd} stage compressor”. Each individual compressor, in this example, consists of a device of the paired rotor forms having a first rotor rotatable about a first axis and having at its periphery a recess bounded by a curved surface, and a second rotor counter-rotatable to the first rotor about a second axis, parallel to the first axis, and having a radial lobe bounded by a curved surface. The rotors intermesh such that, upon rotation, a transient chamber of progressively decreasing volume is defined between them. Other forms of compressor could be used, but the types described above work particularly well. Due to the low or zero friction between the lobe and recess surfaces, and the plural compression cycles during each complete cycle of rotation, the compressors are very efficient.

At each stage, the pressure ratio across the compressor is approximately 4:1 and intercooling is provided using one or more heat exchangers 42, 44 and 46 to remove the heat of compression. Optionally, a heat reservoir 74 is provided for storage of the heat of compression collected from the heat exchangers 42, 44 and 46. In the example shown the heat reservoir is provided as a hot oil reservoir to store oil that circulates as a heat transfer fluid within the heat exchangers 42, 44 and 46. Any other suitable heat reservoir or store could be used and in particular it is noted that any suitable heat transfer fluid could be used within the heat exchangers. For example, water or mixtures of water, oils or aqueous solutions could be used. Also, phase change devices in liquid transport medium could be used as an alternative to conventional heat exchangers as they may be subject to reduced thermal losses when compared with conventional heat exchangers.

In some embodiments, the system or means of air liquefaction of FIG. 8 is provided without the heat reservoir 74 for storage of the heat of compression collected from the heat exchangers 42, 44 and 46. For example the heat collected from the heat exchangers 42, 44 and 46 could simply be exhausted to atmosphere. However, the collected heat, which in some respects can be thought of as a by-product of the liquefaction process, has some significant uses as described above. In particular, in some embodiments the heat is used as the heat source for provision to the engine of FIG. 2 which significantly increases the energy output of the engine as explained above.

In addition the addition of heat, e.g. via the medium of superheated water, provides additional energy to the engine during its cycle of operation. Indeed, in embodiments, the heat added accounts for approaching more than 30% of the power output of the engine. In some embodiments, the heat added accounts for even more of the power output of the engine, e.g. 40 or even 45 or 50% of the power output of the engine. Thus the addition of superheated water has a number of synergistic beneficial effects. Not only can it be used to provide an isothermal energy conversion process, but in doing so can significantly add to the power output of the engine.

At the first stage 54, ambient source air is compressed and delivered to the heat exchanger 42 at 4.5 Bar pressure. Heat is removed in the heat exchanger 42 and transported away to a thermally insulated storage vessel 74 typically with the use of a heat transfer fluid. An optional water condenser 56 may be used to dry the air before it is fed to the second stage compressor 58. At this stage the pressure is increased to 20 Bar and the heat of compression is removed by the heat exchanger 44, and transported for storage before the compressed air is delivered to the third stage compressor 60, where it is again compressed up to a pressure of about 80 Bar before delivery to heat exchanger 46. In this example, this is the final stage at which heat of compression is removed, transported and stored. It will be understood that although in this example three stages of compression and heat exchange are utilised in other embodiments more or less stages could be used. For example if four compression stages are used then a smaller pressure increment could be used between compressors.

The airflow stream from the 3^{rd} stage heat exchanger or intercooler 46 at 80 Bar pressure and approximately ambient temperature, i.e., preferably 290K is then divided into 4 quartiles. The first 3 quartiles are delivered, via conduit 62 equally to each of 3 expanders 66 connected to the lower 3 power lines. These expanders 66 are also preferably formed with paired rotors of the type described above, i.e. consisting of a device of the paired rotor forms having a first rotor rotatable about a first axis and having at its periphery a recess bounded by a curved surface, and a second rotor counter-rotatable to the first rotor about a second axis, parallel to the first axis, and having a radial lobe bounded by a curved surface and wherein the rotors intermesh such that, upon rotation, a transient chamber of progressively increasing volume is defined between them.

The expanders are dimensioned and designed with capacity such that they permit expansion from 80 Bar pressure to ambient in a single expansion stage, giving rise to a very large pressure drop with a large capacity for cooling.

The 4^{th} quartile of flow at 80 Bar pressure and near ambient temperature is directed via conduit 64 successively through each of 3 heat exchangers 48, 50 and 52, each of which is supplied with the cold expanded air from the 3 lower power lines. This 3 stage cooling process brings the temperature of the 4^{th} quartile of compressed air down to 190K, 140K and 105K respectively, whilst its pressure is maintained at 80 Bar. The cold flow from the 4^{th} quartile is then passed directly into a 4^{th} expander 70 of similar form to the first 3 and with capacity to expand the air from 80 Bar to ambient pressure in a single stage. It is this capacity limit which maintains the pressure of the 4^{th} quartile stream at 80 Bar upstream of its final expander. In operation the system for liquefaction of air as shown in FIG. 8 can be operated so as to provide between 1.5 and 3.5 tonnes of liquid air per hour. Typically it would provide about 2.5 tonnes of liquid air per hour.

The expansion of the 4^{th} quartile stream from 80 Bar to ambient pressure results in lowering of its temperature below its condensation point and consequently approximately 76% of this air is liquefied and stored in a thermally insulated reservoir 72. The remaining 24% of gaseous air at very low temperature can be recycled through the cooling heat exchangers. The thermally insulated liquid air reservoir 72 and the hot oil reservoir 74 can both be thought of as energy stores which can thus be used in any way that is desired.

The process of final expansion and liquefaction in the expansion device according to the present invention provides the advantage of eliminating the need for a Joule-Thomson valve as used in many industrial liquefaction systems and recovers the pressure energy of expansion from all 4 expanders, reducing the overall power required for the process. This is an important advantage that the present system provides and enables. Although it is the cooling of the gas that is primarily utilised from the expanders of the 2^{nd} power lines 32, 34 and 36, so as to provide cooling of the fluid within the first power line 30, the use of a low friction expander within each of the 2^{nd} power lines means that as well as getting the benefit of the cooling the expanders are effectively driven by the expanding gas so as to provide a power output and reducing the overall power needs of the system.

In the described system it will be appreciated that plural power lines are provided and that within each power line there is provided at least one expander and at least one compressor. It is preferred that all of the expanders and compressors within the system are of the low friction rotary type described herein although it is possible that one or more of them might not be (so long as at least one of them is). Preferably, within the first power line at least the compressor (or at least one of the compressors where more than one is provided) is of the type having first and second rotors. A first rotor is rotatable about a first axis and has at its periphery a recess bounded by a curved surface, and a second rotor counter-rotatable to said first rotor about a second axis, parallel to said first axis, has a radial lobe bounded by a curved surface, the first and second rotors being coupled for intermeshing rotation. The first and second rotors intermesh in such a manner that on rotation thereof, a transient chamber of variable volume is defined, the transient chamber having a progressively increasing volume between the recess and lobe surfaces. Preferably also the expander has this general form although of course in use the transient chamber will be arranged to increase in volume during a cycle of rotor interaction.

It is a further important advantage arising from the use of the preferred forms of rotary compressors and expanders as explained herein, that the whole process is thereby made highly scalable. This is in marked contrast with currently used systems which are widely available to industry because they use turbo-machinery to deliver the compression and expansion necessary to effectuate liquefaction of air. Such systems are only able to achieve acceptable efficiency in their use of power per unit mass of liquid air produced when designed for large scale applications e.g. typically systems capable of delivering 600 tons/day of liquid air with energy conversion of 0.5 kWHrs per Kg. of liquid air produced. By contrast, systems as described herein are capable of achieving the same rate of energy conversion with a wide range of output from 100 Kg per hour or less up to 600 tons per day. This is because the compressor and expander systems described herein are essentially displacement devices whose operating delivery performance depends largely on the design size of their transient chamber.

The foregoing description of each of several processes nevertheless constitutes all the elements of a single complete cycle in which energy withdrawn from the earth's atmosphere is used to effect a change of state on its own constituents, namely ambient sourced air, to the form in which it attains its maximum density and is a stable form of energy storage. Heat from the compression stages of this process is also stored so that it is effectively re-combined to re-generate the energy in the expansion engine to deliver power for the widest possible range of applications. This energy is subsequently returned to the atmosphere to complete the cycle.

Embodiments of the present invention have been described with particular reference to the examples illustrated. However, it will be appreciated that variations and modifications may be made to the examples described within the scope of the present invention.

1. A cryogen engine, comprising a first rotor rotatable about a first axis and having at its periphery a recess bounded by a curved surface, and a second rotor counter-rotatable to said first rotor about a second axis, parallel to said first axis, and having a radial lobe bounded by a curved surface, the first and second rotors being coupled for intermeshing rotation, wherein
the first and second rotors of each section intermesh in such a manner that on rotation thereof, a transient chamber of variable volume is defined, the transient chamber having a progressively increasing volume between the recess and lobe surfaces;
a cryogen injector arranged to inject a cryogenic fluid into the transient chamber once it has formed, such that expansion of the cryogenic fluid drives the engine.

2. A cryogen engine according to claim 1, comprising a heat source for providing heat to the engine during operation.

3. A cryogen engine according to claim 2, wherein the heat source is super-heated water.

4. A cryogen engine according to claim 3, comprising a super-heated water injector arranged to inject a metered amount of super-heated water into the transient chamber once it has formed, such that an expansion stage of the cycle is substantially isothermal.

5. A cryogen engine according to any of claims 1 to 4, comprising a cryogen source.

6. A cryogen engine according to claim 5, wherein the cryogen source is a storage tank for storing a liquid cryogen.

7. A cryogen engine according to any of claims 1 to 6, comprising a high pressure pump for pumping a cryogen to the cryogen injector.

8. A cryogen engine according to claim 7, wherein the high pressure pump is provided within the storage tank.

9. A cryogen engine according to claim 7, wherein the high pressure pump is provided adjacent to the storage tank.

10. A cryogen engine according to any of claims 1 to 9, wherein the engine comprises end walls enclosing the axial ends of the rotors and wherein one of the end walls has a port positioned for delivery of the cryogen to the transient chamber of varying volume during an expansion cycle shortly after the transient chamber is first defined.

11. A cryogen engine according to claim 10, the port is positioned for delivery of the cryogen to the transient chamber of varying volume during the first 0-10 degrees of rotation of the rotors after the establishment of the transient chamber of varying volume.

12. A cryogen engine according to claim 10 or 11, the end wall has at least two ports and wherein one of them is arranged for the provision of cryogen to the transient chamber of varying volume during an expansion cycle, and another is arranged for the provision of a heated liquid to the transient chamber of varying volume.

13. A cryogen engine according to any of claims 1 to 12, wherein a metered amount of cryogen and heated liquid are provided for an expansion cycle so as to ensure that overall the expansion cycle is isothermal.

14. A cryogen engine according to any of claims 1 to 13, cryogen injector is arranged to inject a metered amount of cryogenic fluid into the transient chamber at near-ambient temperature in a super-critical gaseous state.

15. A method of operating a cryogen engine, the method comprising, in an engine comprising a first rotor rotatable about a first axis and having at its periphery a recess bounded by a curved surface, and a second rotor counter-rotatable to said first rotor about a second axis, parallel to said first axis, and having a radial lobe bounded by a curved surface, the first and second rotors being coupled for intermeshing rotation, wherein the first and second rotors of each section intermesh in such a manner that on rotation thereof, a transient chamber of variable volume is defined, the transient chamber having a progressively increasing volume between the recess and lobe surfaces;
injecting a cryogenic working fluid in super-critical state into the transient chamber once it has formed, such that expansion of the cryogen drives the engine.

16. A method according to claim 15, comprising at the same time as injecting the cryogen or shortly thereafter, injecting a heated fluid into the expansion chamber to achieve isothermal expansion within the transient chamber.

17. A method according to claim 15 or 16, comprising operating an engine according to any of claims 1 to 14.

18. A method of liquefying air, comprising, providing a liquefaction system including at least a first power line and a second power line, wherein the first power line has at least one compressor stage and at least one expander and is arranged to compress air and then expand air so as to provide a product stream of liquid air, and wherein the second power line has at least one compressor stage and at least one expander and is arranged to provide a flow of coolant for the first power line, the method comprising:
in the first power line, receiving a flow of air;
compressing the received air in a compressor having a first rotor rotatable about a first axis and having at its periphery a recess bounded by a curved surface, and a second rotor counter-rotatable to said first rotor about a second axis, parallel to said first axis, and having a radial lobe bounded by a curved surface, the first and second rotors being coupled for intermeshing rotation, wherein the first and second rotors of each section intermesh in such a manner that on rotation thereof, a transient chamber of progressively decreasing volume is defined between the recess and lobe surfaces;
and removing heat from the compressed air;
providing the cooled compressed air to an expander and expanding the air so as to cause a drop in temperature of the air and thereby liquefy the air, wherein the expander has a first rotor rotatable about a first axis and having at its periphery a recess bounded by a curved surface, and a second rotor counter-rotatable to said first rotor about a second axis, parallel to said first axis, and having a radial lobe bounded by a curved surface, the first and second rotors being coupled for intermeshing rotation, wherein the first and second rotors of each section intermesh in such a manner that on rotation thereof, a transient chamber of progressively increasing volume is defined between the recess and lobe surfaces.

19. A method according to claim 18, wherein the second power line has 2 or more compressor stages arranged in series, and wherein the method comprises removing heat from the compressed air at the output of one or more of the plurality of compressor stages before it is provided as an input to the next compressor stage.

20. A method according to claim 19, wherein the second power line has 2 or more compressor stages arranged in series, and wherein the method comprises removing heat from the compressed air at the output of one or more of the plurality of compressor stages before it is provided as an input to the next compressor stage, and wherein the method comprises: coupling cooled air from the compressor of the second power line to one or more heat exchangers thereby to provide cooling of compressed air in the first power line.

21. A method according to any of claims 18 to 20, wherein the method comprises providing a plurality of second power lines and coupling cooled air from an expander of each of the second power lines to provide cooling to the first power line.

22. A method according to any of claims 18 to 21, wherein there are at least three stages of compressor within each power line and they are arranged to provide a compression ratio of between 2:1 and 8:1, preferably between 3:1 and 6:1 and more preferably a compression ratio of 4:1.

23. A system for liquefying air, the system comprising:
a first power line having a compressor having a first rotor rotatable about a first axis and having at its periphery a recess bounded by a curved surface, and a second rotor counter-rotatable to said first rotor about a second axis, parallel to said first axis, and having a radial lobe bounded by a curved surface, the first and second rotors being coupled for intermeshing rotation, wherein the first and second rotors of each section intermesh in such a manner that on rotation thereof, a transient chamber of progressively decreasing volume is defined between the recess and lobe surfaces;
and a heat exchanger for removing heat from the compressed air;
an expander arranged to expand the air so as to cause a drop in temperature of the air and thereby liquefy the air, wherein the expander has a first rotor rotatable about a first axis and having at its periphery a recess bounded by a curved surface, and a second rotor counter-rotatable to said first rotor about a second axis, parallel to said first axis, and having a radial lobe bounded by a curved surface, the first and second rotors being coupled for intermeshing rotation, wherein the first and second rotors of each section intermesh in such a manner that on rotation thereof, a transient chamber of progressively increasing volume is defined between the recess and lobe surfaces.

24. A system according to claim 23, wherein the second power line has at least one compressor stage and at least one expander and is arranged to provide a flow of coolant for the first power line.

25. A system according to claim 24, wherein the second power line has 2 or more compressor stages arranged in series, and
wherein the system has one or more heat exchangers configured in use to remove heat from the compressed air at the output of one or more of the plurality of compressor stages before it is provided as an input to the next compressor stage or to the expander of the 2^{nd} power line.

26. A system according to any of claims 23 to 25, wherein there are provided 2 or more 2^{nd} power lines arranged to provide cooling to the first power line.

27. A cryogen engine, comprising
a first rotor rotatable about a first axis and having at its periphery a recess bounded by a curved surface, and
a second rotor counter-rotatable to said first rotor about a second axis, parallel to said first axis, and having a radial lobe bounded by a curved surface,
the first and second rotors being coupled for intermeshing rotation, wherein the first and second rotors of each section intermesh in such a manner that on rotation thereof, a transient chamber of variable volume is defined, the transient chamber having a progressively increasing volume between the recess and lobe surfaces;
a cryogen injector arranged to inject a charge of cryogenic fluid into the transient chamber once it has formed, such that expansion of the cryogen drives the engine.
